(19) United States
(12) Patent Application Publication
(10) Pub. No.: US 2011/0083290 A1
(43) Pub. Date: Apr. 14, 2011

(54) AVIATION CLEANING WIPES

(76) Inventor: ANTHONY J. BROOKS, Dover, DE (US)

(21) Appl. No.: 12/874,999

(22) Filed: Sep. 2, 2010

Related U.S. Application Data
(60) Provisional application No. 61/272,639, filed on Oct. 14, 2009.

(51) Int. Cl. B08B 1/00

(52) U.S. Cl. 15/104.93

(57) ABSTRACT

The aviation cleaning wipes are hand wipes that are impregnated with castor oil. The cleaning wipes may be packaged in perforated rolls or stacks. The package may take the form of a box, packet, tub or the like. Castor oil is basically the sole fluid used to impregnate the wipes, although a fragrance, a preservative, or the like may be added, if desired. The wipes are particularly useful for cleaning hydraulic fluid or other phosphate ester-based materials from the skin.

### CROSS-REFERENCE TO RELATED APPLICATION

This application claims the benefit of U.S. Provisional Patent Application Ser. No. 61/272,639, filed Oct. 14, 2009.

### BACKGROUND OF THE INVENTION

1. Field of the Invention

The present invention generally relates to cleaning cloths, and more particularly to aviation cleaning wipes for the removal of phosphate ester fluids from the human skin, e.g., ester-based hydraulic fluids of the type commonly encountered by aviation mechanics both in the field and in the shop.

2. Description of the Related Art

Aviation mechanics often are required to employ phosphate ester fluids when servicing aircraft. One such fluid that is commonly used is Skydrol® (skydrol is a trademark of Solutia, Inc. of St. Louis, Mo.). Skydrol® is made up of a group of chemical additives dissolved into a fire-resistant, phosphate ester base stock to form a hydraulic fluid that inhibits corrosion and prevents erosion damage to servo valves. Skydrol® fluids are irritating to human tissue. Gloves and goggles are recommended safety equipment when servicing Skydrol® systems. If the fluid gets on the skin it creates an itchy, red rash with a burning sensation which feels similar to a sunburn. The effects subside within a few hours, and studies indicate that Skydrol causes no permanent damage to human tissue. Heretofore castor oil has been applied to the affected skin areas to neutralize the burning sensation. The castor oil is poured on a shop rag. The castor oil-saturated rag is then used to wipe the affected skin areas. This sceanario involves the expenditure of time and effort in that the mechanic must retrieve a rag and a container of castor oil and then saturate the rag with the castor oil. Furthermore, the disposal of the rag creates a problem. It would certainly be convenient and time-saving if a container or package of easily disposable, castor oil-saturated wipes were readily available for immediate use. Thus, aviation cleaning wipes solving the aforementioned problems are desired.

### SUMMARY OF THE INVENTION

The aviation cleaning wipes are hand wipes that are impregnated with commercial grade castor oil. The cleaning wipes are packaged in perforated rolls or stacks. The package may take the form of a box, packet, tub or the like. Pharmaceutical grade castor oil is basically the sole fluid used to impregnate the wipes, although a fragrance, preservative, or the like may be added, if desired.

Accordingly, the invention presents a cleaning wipe impregnated with castor oil that is packaged for easy and convenient retrieval. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of an aviation cleaning wipe according to the present invention.

FIG. 2 is an exploded, perspective view of a first form of packaging an aviation cleaning wipe according to the present invention.

FIG. 3 is a perspective view of a second form of packaging an aviation cleaning wipe according to the present invention.

FIG. 4 is a perspective view of a third form of packaging an aviation cleaning wipe according to the present invention.

Similar reference characters denote corresponding features consistently throughout the attached drawings.

### DETAILED DESCRIPTION OF THE PREFERRED EMBODIMENTS

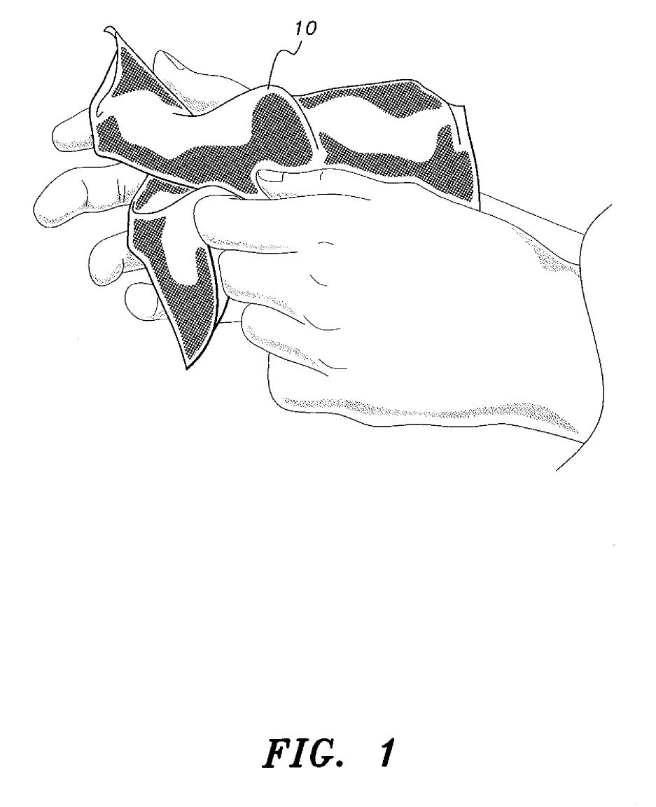

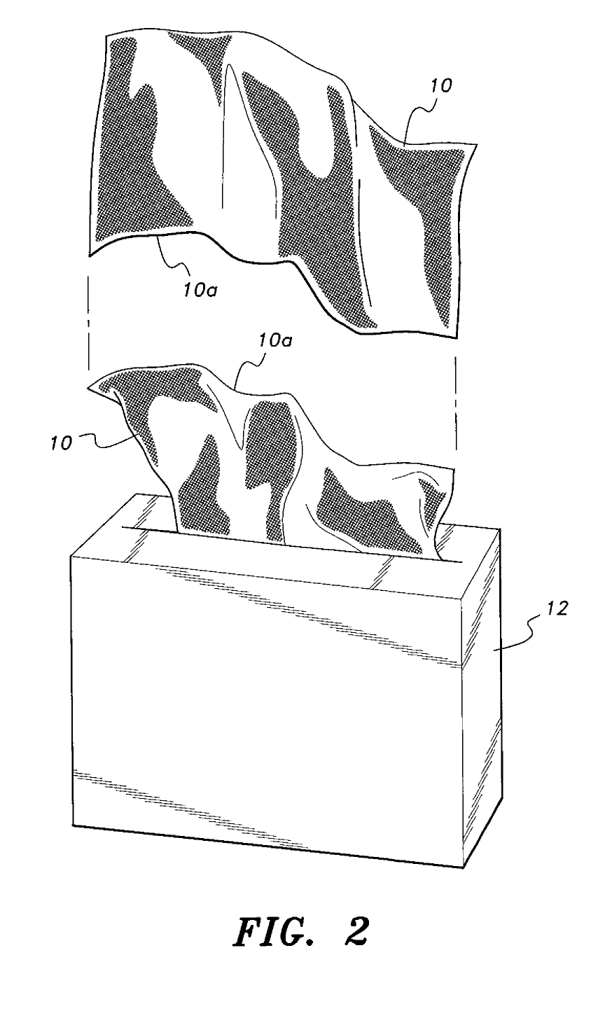

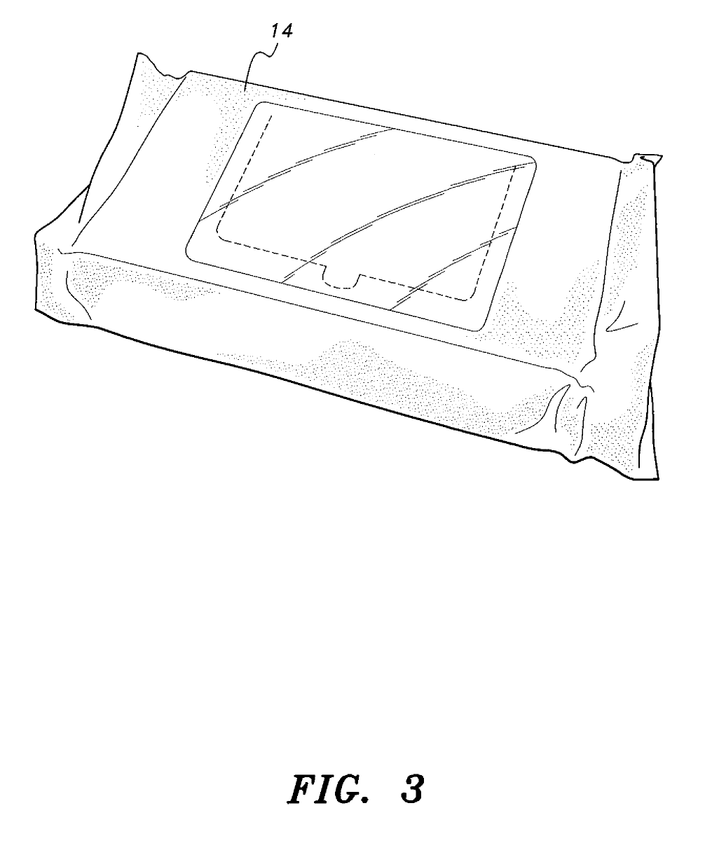

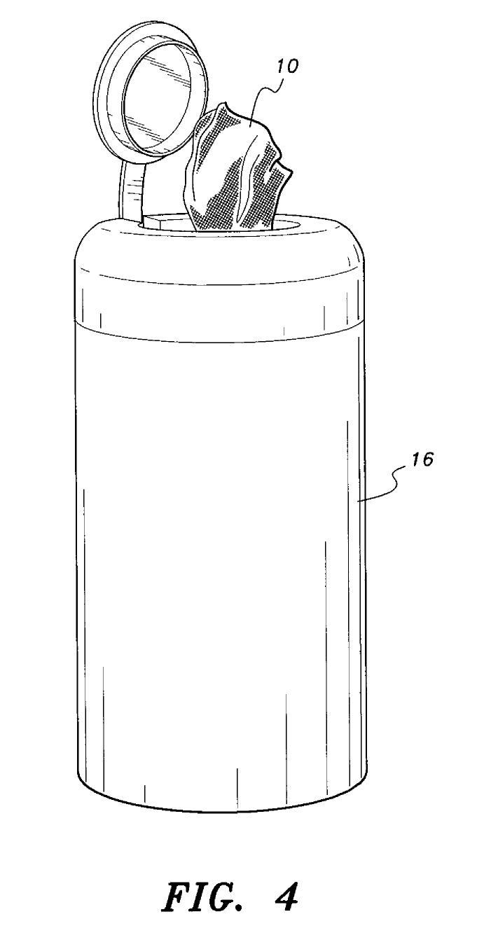

Referring to FIGS. 1-4 of the drawings, the aviation cleaning wipe, generally indicated at 10 in the drawings, is fabricated from a suitably absorbent hygienic sheet of material (fabric or paper) that is capable of being impregnated with a solution comprised almost solely of castor oil, although a fragrance, preservative, or other excipient or inert additive may be added, if desired. The wipes are packaged in such containers as a box 12, a packet 14 or a tub 16, although the foregoing list of exemplary containers is not exclusive. The wipes 10 may be made available in sheet rolls or stacks that are perforated at intervals 10a for quick and easy detachment and retrieval of a single wipe. A package of such wipes 10 can be made easily available at work sites for convenient use when the mechanic needs to clean phosphate ester fluids from the hands or other exposed skin surfaces.

It is to be understood that the present invention is not limited to the embodiments described above, but encompasses any and all embodiments within the scope of the following claims.

I claim:

1. An aviation cleaning wipe, comprising:
a sheet of absorbent material forming a wipe adapted for wiping a person's skin;
a solution of castor oil, the sheet of absorbent material being impregnated with the castor oil solution; and
a container for housing the castor oil-impregnated absorbent material.

2. The aviation cleaning wipe according to claim 1, wherein said container comprises a box.

3. The aviation cleaning wipe according to claim 1, wherein said container comprises a packet.

4. The aviation cleaning wipe according to claim 1, wherein said container comprises a tub.

5. An aviation cleaning wipe, comprising:
a sheet of absorbent material forming a wipe adapted for wiping a person's skin, the sheet being separated into a plurality of sections defined by perforated edges;
a solution of castor oil, the absorbent material being impregnated with the castor oil solution; and
a container for housing the castor oil-impregnated absorbent material.

6. The aviation cleaning wipe according to claim 5, wherein said container comprises a box.

7. The aviation cleaning wipe according to claim 5, wherein said container comprises a packet.

8. The aviation cleaning wipe according to claim 5, wherein said container comprises a tub.

9. An aviation cleaning wipe, comprising:
a sheet of absorbent material forming a wipe adapted for wiping a person's skin, the sheet being separated into a plurality of sections defined by perforated edges;
a solution of pharmaceutical grade castor oil, the absorbent material being impregnated with the pharmaceutical grade castor oil;
a fragrance added to the solution of castor oil; and
a container for housing the castor oil-impregnated absorbent material.

10. The aviation cleaning wipe according to claim 9, wherein further comprising a preservative added to the solution of castor oil.

11. The aviation cleaning wipe according to claim 10, wherein said container comprises a box.

12. The aviation cleaning wipe according to claim 10, wherein said container comprises a packet.

13. The aviation cleaning wipe according to claim 10, wherein said container comprises a tub.
